(19) United States
(12) Patent Application Publication
(10) Pub. No.: US 2005/0174944 A1
(43) Pub. Date: Aug. 11, 2005

(54) Bandwidth regulation

(75) Inventors: Benoit Legault, North Attleboro, MA (US); Alex Leung, Rego Park, NY (US)

Correspondence Address: FOGG AND ASSOCIATES, LLC, P.O. BOX 581339, MINNEAPOLIS, MN, 55458-1339, US

(73) Assignee: ADC Broadband Access Systems, Inc.

(21) Appl. No.: 10/775,410

(22) Filed: Feb. 10, 2004

(51) Int. Cl. H04L 1/00

(52) U.S. Cl. 370/235.1

(57) ABSTRACT

A service provider enables a plurality of subscribers to gain access to a telecommunications network, such as the Internet. The service provider sets a bandwidth usage cap for the subscribers over a given usage period, such as a month. The usage cap is enforced by regulating the rate at which subscribers can send and receive data transmissions over an access network during the usage period. Those subscribers that send or receive data only occasionally will normally experience a transmission rate at or near the peak transmission rate offered by the service provider. However, those subscribers that attempt to send or receive excessive amounts of data will be throttled down to a lower sustained transmission rate, which will prevent them from exceeding the usage cap set by the service provider.

### TECHNICAL FIELD

The present invention relates generally to the field of telecommunications and, in particular, to systems and methods for regulating the bandwidth of subscribers within a telecommunications system.

### BACKGROUND

In some telecommunications systems, a service provider charges a recurring fee to subscribers at regular intervals, such as once per month, in exchange for providing access to a telecommunications network, such as the Internet. When a subscriber gains access to the network through the service provider, the subscriber uses a certain amount of bandwidth to send and receive data transmissions. The amount of bandwidth used by the subscriber varies with the rate at which the subscriber sends and receives transmissions over the network. Therefore, service providers that enable subscribers to send and receive transmissions at relatively high transmission rates typically charge more for access to the network than service providers who offer lower transmission rates to subscribers.

Service providers commonly charge a flat fee for access to the network, regardless of the amount of bandwidth actually used by a subscriber during a given usage period, such as a month. Because the amount of bandwidth used can vary dramatically from one subscriber to the next, many service providers factor in a certain amount of oversubscription, meaning that the service provider offers more subscriptions than can be accommodated at full capacity because it is assumed that not every subscriber will use the full amount of available bandwidth. Because some subscribers may consume far more bandwidth than expected by the service provider, the traditional flat fee billing arrangement can introduce inefficiencies, even if only a small percentage of the subscribers over-use the service.

In an effort to reduce these inefficiencies, some service providers have attempted to implement usage-based billing models, similar to those commonly used by cellular telephone service providers. In one example of such a billing model, a monthly usage cap is identified in the subscription contract and any usage above the cap is billed based on consumption. Attempts to implement these billing models have often been complicated by a number of factors, such as the lack of an existing business infrastructure to support usage-based billing and the introduction of additional costs and liabilities.

### SUMMARY OF THE INVENTION

The above-mentioned inefficiencies associated with traditional subscription and billing arrangements for access to certain telecommunications networks are addressed by embodiments of the present invention and will be understood by reading and studying the following specification.

In one embodiment, a system for regulating the rate at which subscribers can send and receive transmissions over an access network comprises a token/leaky bucket having a capacity corresponding to a maximum number of tokens that can be stored in the token/leaky bucket. Tokens escape from the token/leaky bucket at a sustained rate which is related to the quotient of a usage cap and a usage period. When a data transmission request is received, if there is sufficient capacity within the token/leaky bucket, data is allowed to be transmitted over the access network at a rate of up to a peak transmission rate and tokens are deposited into the token/leaky bucket to reflect the transmission.

In another embodiment, a system for regulating the rate at which subscribers can send and receive transmissions over an access network comprises a token generator that periodically generates a first number of tokens corresponding to a usage cap for the subscribers over a usage period. The system further comprises a leaky bucket into which the token generator periodically deposits tokens, wherein the size of the leaky bucket corresponds to the usage cap, and a token bucket into which the leaky bucket deposits tokens at a sustained rate. The sustained rate is related to the quotient of the usage cap and the usage period. If a sufficient number of tokens are present in the token bucket, data is allowed to be transmitted over the access network at a rate of up to a peak transmission rate and tokens are removed from the token bucket to reflect the transmission.

In another embodiment, a system for regulating the rate at which subscribers can send and receive transmissions over an access network comprises a traffic control element and a leaky bucket configured to hold tokens, which leak out of the leaky bucket at a sustained rate which is related to the quotient of a usage cap and a usage period. The system further comprises a token bucket configured to hold tokens. When a data transmission request is received, the traffic control element checks the number of tokens within the token bucket and, if a selected condition is satisfied, allows the data to be transmitted over the access network at a rate of up to a peak transmission rate and adjusts the number of tokens in the token bucket to reflect the transmission.

In another embodiment, an access network comprises service provider equipment coupled to a telecommunications network and a plurality of communication links coupled to the service provider equipment. A plurality of subscribers can gain access to the telecommunications network through the access network. The service provider equipment regulates the rate at which the subscribers can send or receive data over the access network such that the subscribers do not exceed a selected usage cap over a given usage period.

In another embodiment, an access network comprises service provider equipment coupled to a telecommunications network and comprising a burst counter having a maximum burst allocation value, wherein the value of the burst counter decreases at a rate greater than or equal to a sustained rate that is based at least in part on the quotient of a selected usage cap and a corresponding usage period. The access network further comprises a plurality of communication links coupled to the service provider equipment, wherein the communication links enable a plurality of subscribers to gain access to the telecommunications network through the access network. When a transmission request is received, the service provider equipment determines whether the sum of the burst counter value and the size of the transmission request is less than the maximum burst allocation value and, if so, processes the transmission request and increases the value of the burst counter to reflect the transmission.

In another embodiment, a method for regulating the bandwidth usage of subscribers within a telecommunications system comprises referencing a selected usage cap for a given usage period and providing a burst counter having a maximum burst allocation value. The method further comprises decreasing the value of the burst counter at a rate greater than or equal to a sustained rate, wherein the sustained rate is based at least in part on the quotient of the usage cap and the usage period. The method further comprises determining, when a transmission request is received, whether the sum of the burst counter value and the size of the transmission request is less than the maximum burst allocation value and, if so, processing the transmission request and increasing the value of the burst counter to reflect the transmission.

In another embodiment, a method for regulating the bandwidth usage of subscribers within a telecommunications system comprises providing a token/leaky bucket having a capacity corresponding to a maximum number of tokens that can be stored in the token/leaky bucket and withdrawing tokens from the token/leaky bucket at a sustained rate which is related to the quotient of a usage cap and a usage period. The method further comprises determining, when a transmission request is received, whether there is sufficient capacity within the token/leaky bucket to process the request and, if so, transmitting the data and depositing tokens into the token/leaky bucket to reflect the transmission.

In another embodiment, a method for regulating the bandwidth usage of subscribers within a telecommunications system comprises generating a first number of tokens corresponding to a selected usage cap for the subscribers over a usage period and depositing tokens into a leaky bucket, wherein the size of the leaky bucket corresponds to the usage cap. The method further comprises transferring tokens from the leaky bucket to a token bucket at a sustained rate, which is related to the quotient of the selected usage cap and the usage period, such that the first number of tokens is deposited into the token bucket during the usage period. The method further comprises determining, when a transmission request is received, whether a sufficient number of tokens are present in the token bucket and, if so, processing the transmission request and removing tokens from the token bucket to reflect the transmission.

In another embodiment, a method for regulating the bandwidth usage of subscribers within a telecommunications system comprises providing a leaky bucket configured to hold tokens and providing a token bucket configured to hold tokens. The method further comprises allowing tokens to leak from the leaky bucket at a sustained rate which is related to the quotient of a usage cap and a usage period and, when a transmission request is received, evaluating the number of tokens within the token bucket and, if a selected condition is satisfied, transmitting the data and adjusting the number of tokens within the token bucket to reflect the transmission.

Other embodiments are described and claimed.

### BRIEF DESCRIPTION OF THE DRAWINGS

FIG. 1 is a schematic diagram of one embodiment of a telecommunications system.

FIG. 2 is a block diagram representing one embodiment of a system for regulating bandwidth usage of subscribers within a telecommunications system.

FIG. 3 is a block diagram representing one embodiment of an alternative system for regulating bandwidth usage of subscribers within a telecommunications system.

### DETAILED DESCRIPTION OF THE PREFERRED EMBODIMENT

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

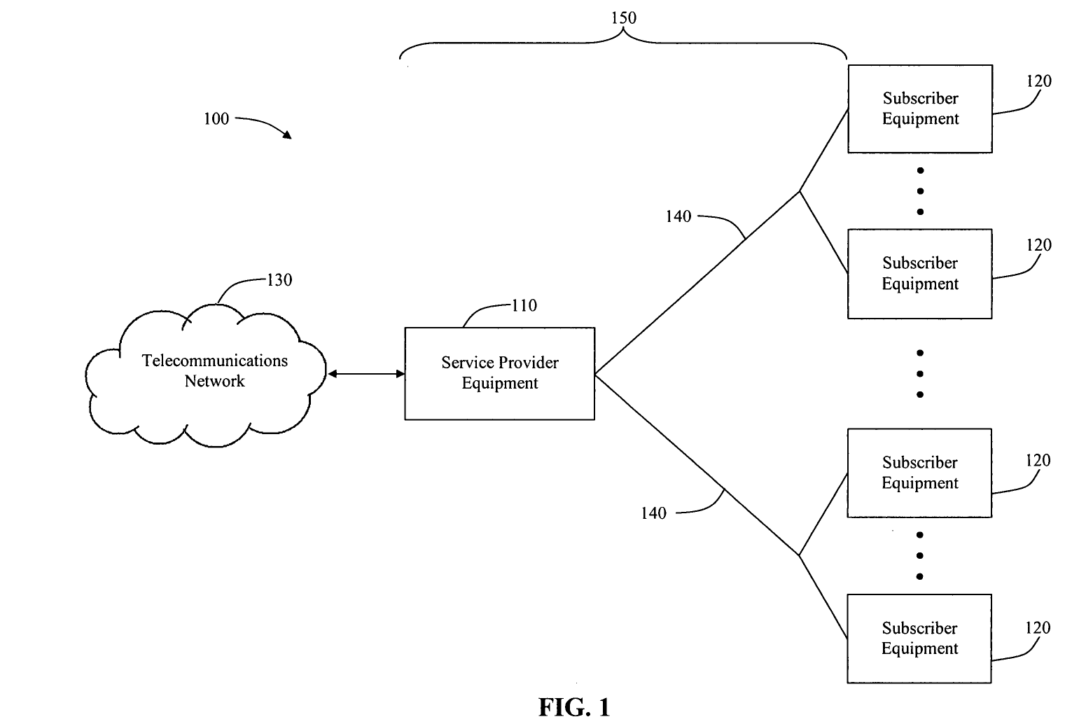

FIG. 1 is a schematic diagram of one embodiment of a telecommunications system 100. In the embodiment illustrated in FIG. 1, the telecommunications system 100 comprises service provider equipment 110 through which a plurality of subscribers using subscriber equipment 120 can gain access to a telecommunications network 130, such as, for example, the Internet. In some embodiments, the subscriber equipment 120 comprises one or more computers, personal digital assistants, cellular telephones, and/or other devices that can be used by individual subscribers to gain access to the telecommunications network 130.

In operation, the service provider equipment 110 communicates with the subscriber equipment 120 via a plurality of communication links 140. Collectively, the service provider equipment 110 and the communication links 140 comprise an access network 150 through which the subscribers can gain access to the telecommunications network 130. In some embodiments, each communication link 140 comprises a physical transmission line, such as, for example, twisted pair, fiber optic cable, or coaxial cable. In other embodiments, the communication links 140 comprise wireless transmission paths. Other exemplary embodiments will become apparent to those of skill in the art in light of the present disclosure.

The access network 150 may comprise a wide variety of devices and processes that are known to those of ordinary skill in the art. For example, various interfaces can be used, such as, for example, a Digital Subscriber Line Access Multiplexer (DSLAM), a Cable Modem Termination System (CMTS), or an edge router, or any other access network structure that uses, or is adaptable to use, classification and tracking of service flows for compliance with defined limitations. In addition, conventional equipment can be used in conjunction with numerous well-known algorithms to police and/or shape the flow of data transmissions to and from the subscriber equipment 120 over the access network 150.

In one embodiment of the present invention, the service provider sets a bandwidth usage cap for each subscriber and enforces the usage cap by implementing an algorithm to control the rate at which the subscriber equipment 120 can send and receive data transmissions over the access network 150. By implementing such an algorithm, the service provider can advantageously control the maximum amount of bandwidth that can be used by any given subscriber, thereby reducing the inefficiencies caused by oversubscription in a traditional flat fee billing arrangement. In addition, unlike previous attempts to reduce such inefficiencies, the present algorithm can be implemented fairly simply with standard modules that are used to police and/or shape the flow of data transmissions to and from the subscriber equipment 120 over the access network 150.

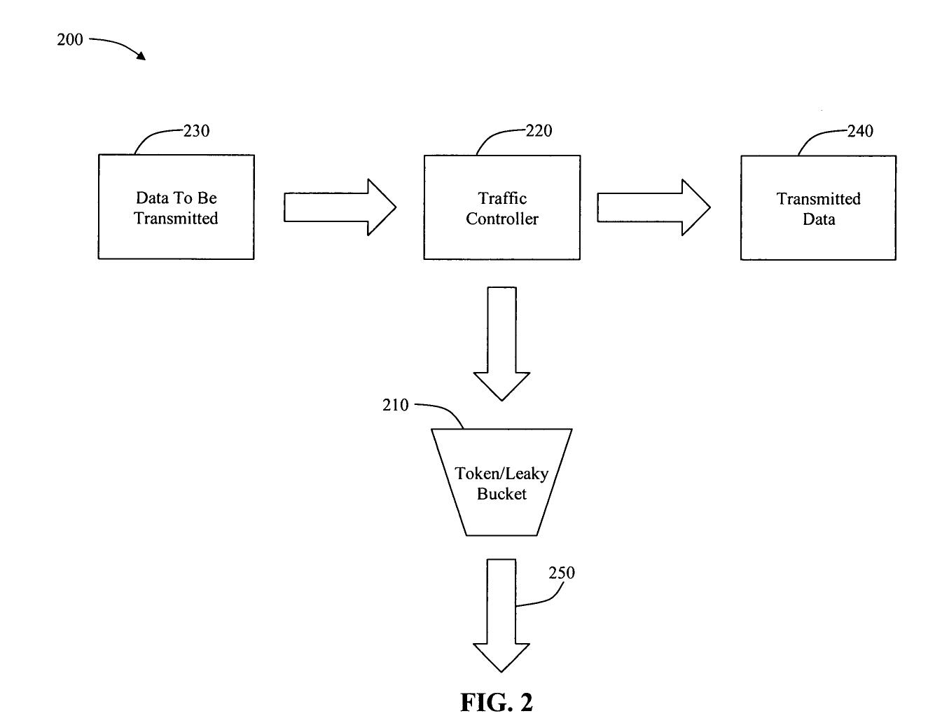

FIG. 2 is a block diagram representing one embodiment of a system 200 for regulating the bandwidth usage of subscribers within a telecommunications system 100. In the illustrated embodiment, the system 200 comprises a token/leaky bucket 210 and a traffic controller 220. The token/leaky bucket 210 comprises a module that can accommodate only a limited number of tokens. Tokens are deposited into the token/leaky bucket 210 when data is transmitted, and tokens constantly leak out of the token/leaky bucket 210 at a given rate 250. Both the capacity of the token/leaky bucket 210 and the rate 250 at which tokens leak out of it can advantageously be selected by the service provider.

In operation, when a request is received to transmit data 230, the traffic controller 220 determines whether there is sufficient capacity within the token/leaky bucket 210 to accommodate the number of tokens corresponding to the size of the transmission request. If so, the data is transmitted and the number of tokens corresponding to the amount of transmitted data 240 is deposited into the token/leaky bucket 210. On the other hand, if there is not sufficient capacity within the token/leaky bucket 210 to process the transmission request, then the traffic controller 220 delays the transmission of the data 230 until a sufficient number of tokens have leaked out of the token/leaky bucket 210 to create enough capacity within the token/leaky bucket 210 to process the request. It should be understood that, as used herein, the term “transmission” is intended to include both the transmission of data to and from the subscriber equipment 120 over the access network 150.

The service provider can advantageously enforce a bandwidth usage cap on subscribers using the system 200 by controlling certain parameters of the token/leaky bucket 210. For example, by selecting the capacity of the token/leaky bucket 210, the service provider can control the usage cap, or the amount of data that can be transmitted to or from a subscriber during a given usage period. Once the capacity of the token/leaky bucket 210 has been reached, any further transmission requests will be delayed until enough tokens have leaked out of the token/leaky bucket 210 to create sufficient capacity for the transmission request.

Thus, when the token/leaky bucket 210 is at or near capacity, the rate 250 at which tokens escape from the token/leaky bucket 210 is the maximum rate at which a subscriber can send or receive transmissions. This rate 250 corresponds to a sustained transmission rate, or the rate at which a subscriber may constantly transmit or receive data during the usage period to reach the predetermined usage cap. In some embodiments, the sustained transmission rate is calculated by dividing the selected usage cap by the length of the corresponding usage period. By allowing tokens to escape from the token/leaky bucket 210 at a rate 250 corresponding to the sustained transmission rate, the service provider ensures that each subscriber can always transmit and receive data at a rate of at least the sustained transmission rate.

Under certain conditions, however, a subscriber may experience an actual transmission rate that is greater than the sustained transmission rate. The actual transmission rate realized by the subscriber is affected by the available capacity within the token/leaky bucket 210 when a transmission request is received. For example, if a request is received after a period of dormancy during which a large capacity has accumulated in the token/leaky bucket 210, then the actual transmission rate realized by the subscriber may be the maximum possible transmission rate offered by the service provider. On the other hand, if the token/leaky bucket 210 is full when a transmission request is received, then the data 230 can only be transmitted to or from the subscriber at the sustained transmission rate, which corresponds to the rate 250 at which the token/leaky bucket 210 is being emptied. Therefore, under these conditions, the actual transmission rate realized by the subscriber will be the sustained transmission rate.

In some embodiments, the system 200 is implemented by including a burst counter for each subscriber in the module(s) of the service provider equipment 110 used to shape or police the flow of traffic over the access network 150. For example, the burst counters could be included in for example, a Digital Subscriber Line Access Multiplexer (DSLAM), a Cable Modem Termination System (CMTS), or an edge router, or any other access network structure that uses, or is adaptable to use, classification and tracking of service flows for compliance with defined limitations. Each burst counter has a maximum burst allocation value which, in some embodiments, is calculated as a percentage of the usage cap set by the service provider.

In operation, the value of a burst counter increases every time a unit of data is transmitted to or from the corresponding subscriber. The value of the burst counter also decreases at a rate corresponding to the sustained transmission rate, or the rate at which a subscriber may constantly transmit or receive data during the usage period to reach the prescribed usage cap. As described above, the sustained transmission rate corresponds to the rate 250 at which tokens leak out of the token/leaky bucket 210.

The burst counter acts as the token/leaky bucket 210 in the example described above. When a transmission request is received, the shaping or policing function of the service provider equipment 110 determines whether the sum of the burst counter value and the number of data units to be transmitted is less than the maximum burst allocation value. If so, then the data is transmitted and the value of the burst counter is increased to reflect the transmission. If not, then the transmission is delayed until the value of the burst counter has decreased by a sufficient amount to allow the data to be transmitted.

In one embodiment, the burst counter is allowed to reach a negative value equal to the maximum burst allocation value minus the predetermined usage cap. In addition, if the service provider elects to allow the rollover of unused credits, then the negative value that the burst counter is allowed to reach is increased by the maximum amount of rollover credit allowed.

For example, if the service provider sets a 30-day usage cap of 30 GB and a maximum burst allocation value of 1 GB, then the burst counter will vary between the values of +8 billion (which corresponds to 1 GB of data) and −232 billion (which corresponds to −29 GB of data). In addition, if the service provider offers a rollover of up to 30 days' worth of unused credits, then the burst counter will vary between the values of +8 billion and −472 billion (which corresponds to −59 GB of data).

In some embodiments, the service provider offers a minimum guaranteed transmission rate to subscribers, which may be greater than the sustained transmission rate. In these embodiments, the rate at which the burst counter decreases depends on its value. In one embodiment, for example, if the burst counter contains a positive value, it will decrease at the greater of the minimum guaranteed transmission rate and the sustained transmission rate. On the other hand, if the burst counter contains a negative value, then it will simply decrease at the sustained transmission rate. Using this approach, a subscriber will always be allowed to send and receive data at a rate of at least the minimum guaranteed transmission rate.

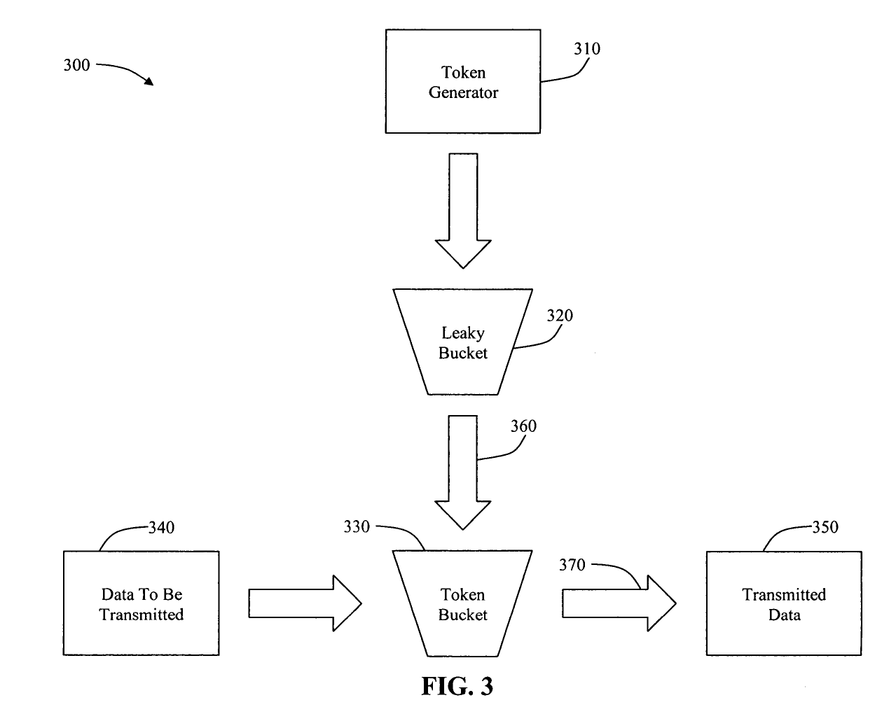

FIG. 3 is a block diagram representing one embodiment of an alternative system 300 for regulating the bandwidth usage of subscribers within a telecommunications system 100. In the embodiment illustrated in FIG. 3, the system 300 comprises a token generator 310 that periodically generates tokens and deposits them into a leaky bucket 320, which is a well-known module that allows the data stored therein to escape at a given rate. In the system 300 illustrated in FIG. 3, for example, the leaky bucket 320 receives tokens from the token generator 310 and deposits them at a given rate into a token bucket 330.

Like the leaky bucket, a token bucket is a module that is well-known to those of ordinary skill in the art. The token bucket module regulates the transmission of data packets by determining whether there are enough tokens in the bucket to process a given transmission request before the data is allowed to be transmitted. For example, as illustrated in FIG. 2, when a request is received to transmit data 340, the module determines whether there are enough tokens in the token bucket 330 to process the request. If so, the data is transmitted and the number of tokens corresponding to the amount of transmitted data 350 is removed from the token bucket 330. On the other hand, if there are not enough tokens in the token bucket 330 to process the request, then the data 340 is not transmitted until a sufficient number of tokens have been deposited into the token bucket 330.

The system 300 can be used to enforce a bandwidth usage cap on subscribers using techniques similar to those described above in connection with the system 200 illustrated in FIG. 2. For example, the service provider can set a usage cap for a given usage period by controlling the size of the leaky bucket 320. In other words, the leaky bucket 320 can be configured to hold only the number of tokens corresponding to the amount of data that a subscriber is authorized to transmit or receive during the usage period. Once a subscriber has used this number of tokens during the usage period, any further transmission requests will be delayed until the supply of tokens is replenished by the token generator 310 during the following usage period.

The system 300 illustrated in FIG. 3 can also be used to provide a subscriber with a sustained transmission rate during a given usage period. As described above, the sustained transmission rate can be calculated by dividing the usage cap set by the service provider by the length of the corresponding usage period. Thus, the sustained transmission rate is the rate at which a subscriber may constantly transmit or receive data during the usage period to reach the predetermined usage cap. In the system 300, the sustained transmission rate corresponds to the rate 360 at which tokens are allowed to escape from the leaky bucket 320 to be deposited into the token bucket 330. By depositing tokens into the token bucket 330 at a rate 360 corresponding to the sustained transmission rate, the service provider ensures that each subscriber can always transmit and receive data at a rate of at least the sustained transmission rate.

As described above, however, many subscribers will typically experience an actual transmission rate 370 that is greater than the sustained transmission rate. The actual transmission rate 370 realized by the subscriber is affected by the number of tokens available in the token bucket 330 when a transmission request is received. For example, if a request is received after a period of dormancy during which a large number of tokens have accumulated in the token bucket 330, then the actual transmission rate 370 realized by the subscriber may be the maximum possible transmission rate offered by the service provider. On the other hand, if the token bucket 330 is empty when a transmission request is received, then the data 340 can only be transmitted to or from the subscriber at the sustained transmission rate, which corresponds to the rate 360 at which the token bucket 330 is being replenished. Therefore, under these conditions, the actual transmission rate 370 realized by the subscriber will be the sustained transmission rate.

As discussed above, tokens can accumulate in a subscriber's token bucket 330 during periods of low activity or dormancy. Therefore, the size of the token bucket 330 determines the number of tokens that can be accumulated by a subscriber as credits toward future transmission requests. The service provider can advantageously select the size of the token bucket 330 to control this parameter. For example, in some embodiments, the token bucket 330 is sized such that the maximum amount of credit that a subscriber can accumulate corresponds to the usage cap set by the service provider. In other embodiments, the size of the token bucket 330 is greater than the number of tokens corresponding to the usage cap. In these embodiments, tokens that are not used by a subscriber during a given usage period rollover, and can be used as credits toward transmission requests in future usage periods.

Numerous variations are possible for the particular manner in which tokens are generated and deposited into the leaky bucket 320 and into the token bucket 330. For example, in some embodiments, the number of tokens corresponding to the usage cap is generated and deposited into the leaky bucket 320 once at the beginning of each usage period. In other embodiments, a smaller number of tokens is generated and deposited into the leaky bucket 320 periodically throughout each usage period. In some embodiments, a predetermined number of tokens is deposited directly into the token bucket 330 when a subscription is initiated or at the beginning of each usage period so that the subscribers enjoy an actual transmission rate 370 greater than the sustained transmission rate for a limited number of transmission requests at the beginning of their subscriptions or at the beginning of each usage period. Additional tokens can also be deposited into the token bucket 330 periodically for promotional events or other reasons within the discretion of the service provider. In some embodiments, the token bucket 330 is emptied at the end of each usage period to prevent subscribers from rolling over any credits from one usage period to the next. Many other variations will become apparent to those of ordinary skill in the art in light of the present disclosure.

In addition, numerous variations are possible for determining the actual transmission rate 370 realized by a subscriber. For example, in some embodiments, as described above, data is always transmitted at the maximum available transmission rate based on the number of tokens in the token bucket 330 when a transmission request is received. In these embodiments, there may be a sharp decline in the actual transmission rate 370 when, in response to a given transmission request, the token bucket 330 is emptied, and the subscriber is suddenly throttled down to the sustained transmission rate. Therefore, in some embodiments, the actual transmission rate 370 is gradually decreased from the maximum possible transmission rate as tokens are removed from the token bucket 330 to ease the transition to the sustained transmission rate.

Moreover, in some embodiments, the service provider may optionally provide a guaranteed minimum transmission rate that is greater than the sustained transmission rate. In these embodiments, when the number of tokens in the token bucket 330 falls below a certain threshold, tokens are deposited into the token bucket 330 at the guaranteed minimum transmission rate rather than the sustained transmission rate.

In one specific exemplary embodiment, a service provider offers access to the Internet at a peak transmission rate of 1.5 megabits per second (Mbps) and sets a monthly usage cap of 40 gigabytes (GB). In this example, the sustained transmission rate is 123 kilobits per second (Kbps), which is calculated by dividing the usage cap of 40 GB by the usage period of 30 days. The service provider also provides a monthly allocation of 1 GB of data that can be transmitted at the peak transmission rate of 1.5 Mbps before a subscriber is throttled down to the sustained transmission rate of 123 Kbps. In addition, as an incentive for initiating a subscription, the service provider offers an up-front allocation of 5 GB of data when a subscription is initiated that can be transmitted at the peak transmission rate of 1.5 Mbps.

In this example, when a new subscription is initiated, 6 GB worth of tokens are deposited directly into the token bucket 330 (5 GB for initiating the subscription plus 1 GB for the first month), and 39 GB worth of tokens are deposited into the leaky bucket 320. If the subscriber immediately begins making constant transmission requests, then the first 6 GB of data will be transmitted at the peak transmission rate of 1.5 Mbps due to the initial deposit of 6 GB worth of tokens into the token bucket 330. Following this initial period, the subscriber will be permitted to transmit or receive an additional 39 GB of data during the remainder of the month due to the deposit of 39 GB worth of tokens into the leaky bucket 320. If the subscriber continues to make constant transmission requests, then, unlike the first 6 GB of data, the remaining 39 GB of data will be transmitted to or from the subscriber at or near the sustained transmission rate of 123 Kbps, which corresponds to the rate 360 at which tokens are deposited from the leaky bucket 320 into the token bucket 330.

At the beginning of the following month, another 40 GB worth of tokens will be generated by the token generator 310, of which 1 GB worth of tokens will be deposited directly into the token bucket 330. The remaining 39 GB worth of tokens will be deposited into the leaky bucket 320. These tokens will be deposited from the leaky bucket 320 into the token bucket 330 at a rate 360 corresponding to the sustained transmission rate of 123 Kbps. If the subscriber does not make any transmission requests during the first 15 days of the month, then 20 GB worth of tokens will accumulate in the token bucket 330 during that period. If the subscriber then begins making constant transmission requests on the 16th day of the month, then 20 GB of data will be transmitted at the peak transmission rate of 1.5 Mbps due to the accumulation of 20 GB worth of tokens in the token bucket 330. Once this accumulation of tokens has been used, however, the subscriber will be throttled down to the sustained transmission rate of 123 Kbps until another supply of tokens has accumulated in the token bucket 330.

In some embodiments, if there are any tokens remaining in the token bucket 330 at the end of the month, these tokens rollover and can be used as credits toward transmission requests during the following month. In other embodiments, any tokens remaining in the token bucket 330 at the end of the month are simply discarded.

It should be understood that, although a usage period of a month has been described in connection with one exemplary embodiment, the service provider may select the usage period to be any length of time. For example, the usage period may be a day, a week, a month, a quarter, a year, or any other period of time.

Like the system 200 described above, the system 300 illustrated in FIG. 3 can also be implemented by including a burst counter for each subscriber in the module(s) of the service provider equipment 110 used to shape or police the flow of traffic over the access network 150. For example, the algorithms described above may be implemented in whole or in part in various embodiments in a machine readable medium comprising machine readable instructions for causing a computer, such as, for example, a DSLAM, a CMTS, or an edge router, to perform the algorithm. As is well known to those of skill in the art, a computer program runs on a central processing unit out of main memory, and may be transferred to main memory from permanent storage via disk drive or CD-ROM drive when stored on removable media or via a network connection or modem connection when stored outside of the computer, or via other types of computer or machine readable media from which it can be read and utilized.

Such machine readable media may include software modules and computer programs. The computer programs may comprise multiple modules or objects to perform the algorithms described above. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art. Further, the method and apparatus may be located either end of a communication link, e.g., on service provider equipment located at a head end or a remote site as well as on equipment located at a customer's premises.

The algorithms described above present a number of distinct advantages over conventional approaches. For example, the algorithms described above enable a service provider to control the maximum bandwidth consumption of any given subscriber during any usage period. As a result, the inefficiencies associated with oversubscription in a traditional flat fee billing model for access to a telecommunications network 130 can advantageously be reduced. In addition, the algorithms described above can advantageously be implemented with standard modules that are used to police and/or shape the flow of data transmissions to and from the subscriber equipment 120 over the access network 150.

Moreover, by using the algorithms described above, the transmission rate experienced by a subscriber will advantageously vary based on the amount of bandwidth used by the subscriber during a given usage period. Accordingly, many typical subscribers that send or receive data only occasionally will normally experience a transmission rate at or near the peak transmission rate offered by the service provider. On the other hand, those subscribers that attempt to send or receive excessive amounts of data will be throttled down to a transmission rate at or near the sustained transmission rate, and will not be allowed to exceed the usage cap set by the service provider during a given usage period. These and other advantages associated with embodiments of the present invention will become apparent to those of ordinary skill in the art in light of the present disclosure.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

1. A system for regulating the rate at which subscribers can send and receive transmissions over an access network, the system comprising:
a traffic controller; and
a token/leaky bucket having a capacity corresponding to a maximum number of tokens that can be stored in the token/leaky bucket;
wherein tokens escape from the token/leaky bucket at a sustained rate which is related to the quotient of a usage cap and a usage period, and
wherein, in response to a data transmission request, the traffic controller determines whether there is sufficient capacity within the token/leaky bucket to process the request and, if so, allows the data to be transmitted over the access network at a rate of up to a peak transmission rate and deposits tokens into the token/leaky bucket to reflect the transmission.

2. The system of claim 1, wherein a selected number of tokens is withdrawn from the token/leaky bucket when a subscription is initiated.

3. The system of claim 1, wherein a selected number of tokens is withdrawn the token/leaky bucket at the beginning of each usage period.

4. The system of claim 1, wherein additional tokens are periodically withdrawn from the token/leaky bucket.

5. The system of claim 1, wherein the number of tokens within the token/leaky bucket is brought to zero at the end of each usage period.

6. The system of claim 1, wherein the number of tokens within the token/leaky bucket is not brought to zero at the end of each usage period.

7. A system for regulating the rate at which subscribers can send and receive transmissions over an access network, the system comprising:
a token generator that periodically generates a first number of tokens corresponding to a usage cap for the subscribers over a usage period;
a leaky bucket into which the token generator periodically deposits tokens, wherein the size of the leaky bucket corresponds to the usage cap; and
a token bucket into which the leaky bucket deposits tokens at a sustained rate,
wherein the sustained rate is related to the quotient of the usage cap and the usage period, and
wherein, if a sufficient number of tokens are present in the token bucket, data is allowed to be transmitted over the access network at a rate of up to a peak transmission rate and tokens are removed from the token bucket to reflect the transmission.

8. The system of claim 7, wherein the first number of tokens is generated and deposited into the leaky bucket and/or the token bucket once during the usage period.

9. The system of claim 7, wherein a number of tokens smaller than the first number of tokens is generated and deposited into the leaky bucket and/or the token bucket periodically throughout the usage period.

10. The system of claim 7, wherein a selected number of tokens is deposited directly into the token bucket when a subscription is initiated.

11. The system of claim 7, wherein a selected number of tokens is deposited directly into the token bucket at the beginning of each usage period.

12. The system of claim 7, wherein additional tokens are periodically generated and deposited into the leaky bucket and/or the token bucket.

13. The system of claim 7, wherein the token bucket is emptied at the end of each usage period.

14. The system of claim 7, wherein tokens remaining in the token bucket at the end of a usage period rollover such that they can be used as credits toward transmission requests in future usage periods.

15. A system for regulating the rate at which subscribers can send and receive transmissions over an access network, the system comprising:
a traffic control element;
a leaky bucket configured to hold tokens, which leak out of the leaky bucket at a sustained rate which is related to the quotient of a usage cap and a usage period, and
a token bucket configured to hold tokens,
wherein, in response to a data transmission request, the traffic control element checks the number of tokens within the token bucket and, if a selected condition is satisfied, allows the data to be transmitted over the access network at a rate of up to a peak transmission rate and adjusts the number of tokens in the token bucket to reflect the transmission.

16. The system of claim 15, wherein the leaky bucket and the token bucket comprise the same bucket.

17. The system of claim 15, wherein the leaky bucket and the token bucket comprise separate buckets.

18. The system of claim 15, wherein tokens are deposited into the token bucket when data is transmitted and the selected condition is that the token bucket has sufficient capacity to accommodate the number of tokens corresponding to the transmission request.

19. The system of claim 15, wherein tokens are withdrawn from the token bucket when data is transmitted and the selected condition is that the token bucket has enough tokens to process the transmission request.

20. An access network comprising:
service provider equipment coupled to a telecommunications network; and
a plurality of communication links coupled to the service provider equipment,
wherein a plurality of subscribers can gain access to the telecommunications network through the access network, and
wherein the service provider equipment regulates the rate at which the subscribers can send or receive data over the access network such that the subscribers do not exceed a selected usage cap over a given usage period.

21. The access network of claim 20, wherein the telecommunications network comprises the Internet.

22. The access network of claim 20, wherein the service provider equipment comprises a DSLAM, a CMTS, and/or an edge router.

23. The access network of claim 20, wherein the communication links comprise twisted pair, fiber optic cable, and/or coaxial cable.

24. The access network of claim 20, wherein the communication links comprise wireless communication paths.

25. The access network of claim 20, wherein the usage cap and the usage period are selected by a service provider.

26. The access network of claim 20, wherein the usage period is a day, a week, a month, a quarter, or a year.

27. The access network of claim 20, wherein the subscribers gain access to the telecommunications network using one or more computers, personal digital assistants, and/or cellular telephones.

28. The access network of claim 20, wherein the subscribers can send or receive data over the access network at a rate of at least a sustained transmission rate, which is determined at least in part by dividing the usage cap by the length of the usage period.

29. The access network of claim 27, wherein the subscribers experience a peak transmission rate for a limited number of transmissions at the beginning of the usage period before being throttled down to the sustained transmission rate.

30. The access network of claim 29, wherein a gradual transition is made from the peak transmission rate to the sustained transmission rate.

31. An access network comprising:
service provider equipment coupled to a telecommunications network and comprising a burst counter having a maximum burst allocation value, wherein the value of the burst counter decreases at a rate greater than or equal to a sustained rate that is based at least in part on the quotient of a selected usage cap and a corresponding usage period; and
a plurality of communication links coupled to the service provider equipment, wherein the communication links enable a plurality of subscribers to gain access to the telecommunications network through the access network, and
wherein, when a transmission request is received, the service provider equipment determines whether the sum of the burst counter value and the size of the transmission request is less than the maximum burst allocation value and, if so, processes the transmission request and increases the value of the burst counter to reflect the transmission.

32. The access network of claim 31, wherein the telecommunications network comprises the Internet.

33. The access network of claim 31, wherein the service provider equipment comprises a DSLAM, a CMTS, and/or an edge router.

34. The access network of claim 31, wherein the communication links comprise twisted pair, fiber optic cable, and/or coaxial cable.

35. The access network of claim 31, wherein the communication links comprise wireless communication paths.

36. The access network of claim 31, wherein the usage cap and the usage period are selected by a service provider.

37. The access network of claim 31, wherein the usage period is a day, a week, a month, a quarter, or a year.

38. The access network of claim 31, wherein the subscribers gain access to the telecommunications network using one or more computers, personal digital assistants, and/or cellular telephones.

39. A method for regulating the bandwidth usage of subscribers within a telecommunications system, the method comprising:
referencing a selected usage cap for a given usage period;
providing a burst counter having a maximum burst allocation value;
decreasing the value of the burst counter at a rate greater than or equal to a sustained rate, wherein the sustained rate is based at least in part on the quotient of the usage cap and the usage period; and
when a transmission request is received, determining whether the sum of the burst counter value and the size of the transmission request is less than the maximum burst allocation value and, if so, processing the transmission request and increasing the value of the burst counter to reflect the transmission.

40. The method of claim 39, wherein the usage cap and the usage period are set by a service provider.

41. The method of claim 39, wherein the maximum burst allocation value is a selected percentage of the usage cap.

42. The method of claim 39, wherein the burst counter is allowed to reach a negative value equal to the maximum burst allocation value minus the selected usage cap.

43. The method of claim 39, wherein the burst counter is allowed to reach a negative value equal to the maximum burst allocation value minus the selected usage cap minus an amount of allowed rollover credit.

44. The method of claim 39, wherein, if the value of the burst counter is positive, then the burst counter decreases at the greater of a minimum guaranteed rate and the sustained rate, and, if the value of the burst counter is negative, then the burst counter decreases at the sustained rate.

45. A method for regulating the bandwidth usage of subscribers within a telecommunications system, the method comprising:
providing a token/leaky bucket having a capacity corresponding to a maximum number of tokens that can be stored in the token/leaky bucket;
withdrawing tokens from the token/leaky bucket at a sustained rate which is related to the quotient of a usage cap and a usage period, and
when a transmission request is received, determining whether there is sufficient capacity within the token/leaky bucket to process the request and, if so, transmitting the data and depositing tokens into the token/leaky bucket to reflect the transmission.

46. The method of claim 45, wherein a selected number of tokens is withdrawn from the token/leaky bucket when a subscription is initiated.

47. The method of claim 45, wherein a selected number of tokens is withdrawn from the token/leaky bucket at the beginning of each usage period.

48. The method of claim 45, wherein additional tokens are periodically withdrawn from the token/leaky bucket.

49. The method of claim 45, wherein the number of tokens within the token/leaky bucket is brought to zero at the end of each usage period.

50. The method of claim 45, wherein the number of tokens within the token/leaky bucket is not brought to zero at the end of each usage period.

51. A method for regulating the bandwidth usage of subscribers within a telecommunications system, the method comprising:
generating a first number of tokens corresponding to a selected usage cap for the subscribers over a usage period;
depositing tokens into a leaky bucket, wherein the size of the leaky bucket corresponds to the usage cap; and
transferring tokens from the leaky bucket to a token bucket at a sustained rate, which is related to the quotient of the selected usage cap and the usage period, such that the first number of tokens is deposited into the token bucket during the usage period, and
when a transmission request is received, determining whether a sufficient number of tokens are present in the token bucket to process the request and, if so, transmitting the data and removing tokens from the token bucket to reflect the transmission.

52. The method of claim 51, wherein the first number of tokens is generated and deposited into the leaky bucket and/or the token bucket once during the usage period.

53. The method of claim 51, wherein a number of tokens smaller than the first number of tokens is generated and deposited into the leaky bucket and/or the token bucket periodically throughout the usage period.

54. The method of claim 51, wherein a selected number of tokens is deposited directly into the token bucket when a subscription is initiated.

55. The method of claim 51, wherein a selected number of tokens is deposited directly into the token bucket at the beginning of each usage period.

56. The method of claim 51, wherein additional tokens are periodically generated and deposited into the leaky bucket and/or the token bucket.

57. The method of claim 51, wherein the token bucket is emptied at the end of each usage period.

58. The method of claim 51, wherein tokens remaining in the token bucket at the end of a usage period rollover such that they can be used as credits toward transmission requests in future usage periods.

59. A method for regulating the bandwidth usage of subscribers within a telecommunications system, the method comprising:
providing a leaky bucket configured to hold tokens;
providing a token bucket configured to hold tokens;
allowing tokens to leak from the leaky bucket at a sustained rate which is related to the quotient of a usage cap and a usage period, and
when a transmission request is received, evaluating the number of tokens within the token bucket and, if a selected condition is satisfied, transmitting the data and adjusting the number of tokens within the token bucket to reflect the transmission.

60. The method of claim 59, wherein the leaky bucket and the token bucket comprise the same bucket.

61. The method of claim 59, wherein the leaky bucket and the token bucket comprise separate buckets.

62. The method of claim 59, wherein tokens are deposited into the token bucket when data is transmitted and the selected condition is that the token bucket has sufficient capacity to accommodate the number of tokens corresponding to the transmission request.

63. The method of claim 59, wherein tokens are withdrawn from the token bucket when data is transmitted and the selected condition is that the token bucket has enough tokens to process the transmission request.

64. A machine readable medium comprising machine readable instructions for causing a computer to perform a method comprising:
referencing a selected usage cap for a given usage period;
providing a burst counter having a maximum burst allocation value;
decreasing the value of the burst counter at a rate greater than or equal to a sustained rate, wherein the sustained rate is based at least in part on the quotient of the usage cap and the usage period; and
when a transmission request is received, determining whether the sum of the burst counter value and the size of the transmission request is less than the maximum burst allocation value and, if so, processing the transmission request and increasing the value of the burst counter to reflect the transmission.

65. The machine readable medium of claim 64, wherein the usage cap and the usage period are set by a service provider.

66. The machine readable medium of claim 64, wherein the maximum burst allocation value is a selected percentage of the usage cap.

67. The machine readable medium of claim 64, wherein the burst counter is allowed to reach a negative value equal to the maximum burst allocation value minus the selected usage cap.

68. The machine readable medium of claim 64, wherein the burst counter is allowed to reach a negative value equal to the maximum burst allocation value minus the selected usage cap minus an amount of allowed rollover credit.

69. The machine readable medium of claim 64, wherein, if the value of the burst counter is positive, then the burst counter decreases at the greater of a minimum guaranteed rate and the sustained rate, and, if the value of the burst counter is negative, then the burst counter decreases at the sustained rate.
